(19) United States
(12) Patent Application Publication
(10) Pub. No.: US 2014/0033231 A1
(43) Pub. Date: Jan. 30, 2014

(54) ELECTRONIC DEVICE WITH A FUNCTION OF ALERTING RUNNING APPLICATIONS AND METHOD THEREOF

(71) Applicants: HON HAI PRECISION INDUSTRY CO., LTD., New Taipei (TW); Fu Tai Hua Industry (Shenzhen) Co., Ltd., Shenzhen (CN)

(72) Inventors: LING LI, Shenzhen (CN); CHIH-YUAN YANG, New Taipei (TW); SUO-BING SU, New Taipei (TW)

(21) Appl. No.: 13/926,078

(22) Filed: Jun. 25, 2013

(30) Foreign Application Priority Data
Jul. 27, 2012 (CN) 2012102626491

(51) Int. Cl. G06F 9/54

(52) U.S. Cl. CPC G06F 9/542
USPC 719/318

(57) ABSTRACT

A method for alerting running application includes steps of producing the input signals in response to user operation, detecting whether the electronic device is at the standby state, determining which applications are running, determining audio files corresponding to the determined applications according to the relationship table stored in a storage unit, and playing the determined audio files and controlling the audio output unit to output audio signals corresponding to the audio files.

### BACKGROUND

1. Technical Field

The present disclosure relates to electronic devices, and particularly to an electronic device with function of alerting running applications and method thereof.

2. Description of Related Art

Electronic devices such as smart phones and tablet computers usually run a number of applications at the same time in response to user operations, such as a reader, a browser, or games. If the user does not operate the electronic device for a period of time, the electronic device would usually lock or enter a standby state. When the user operates the electronic device again, the user may forget which applications have been opened. The applications continue running and consume power, which uses power.

An electronic device with function of alerting current running application to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of one embodiment of an electronic device with a function of alerting running application.

FIG. 2 is a flowchart illustrating a method for alerting running application.

### DETAILED DESCRIPTION

Embodiments of the present disclosure will be described with reference to the accompanying drawings.

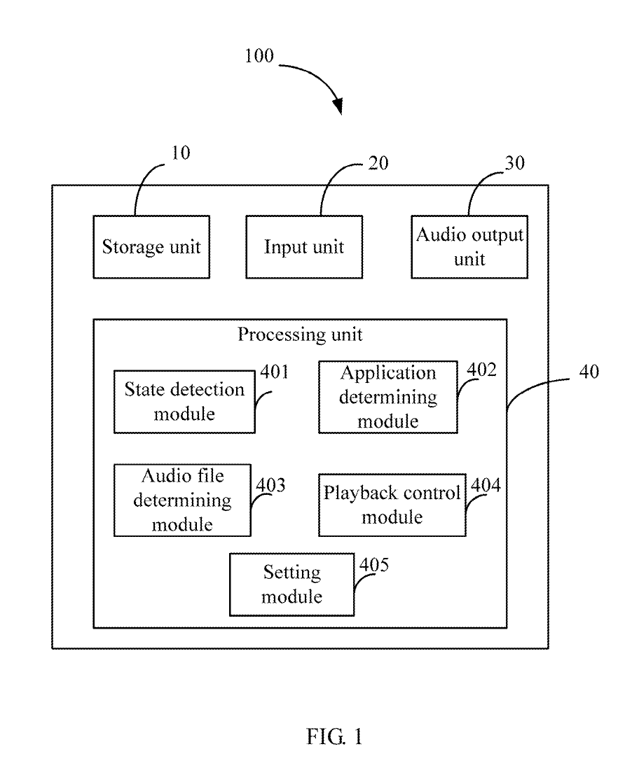

FIG. 1 illustrates a block diagram of one embodiment of an electronic device 100 with a function of alerting running applications. The electronic device 100 includes a storage unit 10, an input unit 20, an audio output unit 30, and a processing unit 40. The electronic device 100 has a number of applications installed, such as a reader, browser, calculator, games. In the embodiment, the electronic device 100 can be a mobile phone or a tablet computer.

The storage unit 10 stores a number of audio files and a relationship table. The relationship table defines relationships between the applications and the audio files. In one embodiment, different applications are related to different audio files.

The input unit 20 is used to produce input signals in response to user operations. The input unit 20 can be a keyboard, a touch pad, a touch screen, or buttons.

The audio output unit 30 is used to output audio signals. The audio output unit 30 can be a loudspeaker or an earphone, for example.

The processing unit 40 is connected to the storage unit 10, the input unit 20, and the audio output unit 30. The processing unit 40 is programmed to include a state detection module 401, an application determining module 402, an audio file determining module 403, and a playback control module 404.

The state detection module 401 is used to detect whether the electronic device 100 is at a standby state when receiving the input signal from the input unit 20. In one embodiment, the input signal produced by the input unit 20 can be an unlocking command signal.

The application determining module 402 determines which applications are running when the state detection module 401 detects the electronic device 100 is at the standby state.

The audio file determining module 403 determines audio files corresponding to the determined applications according to the relationship table stored in the storage unit 10.

The playback control module 404 is used to play the determined audio files and control the audio output unit 40 to output audio signals corresponding to the audio files. If there is only one application running, the playback control module 404 plays a single audio file corresponding to the application. If there are more than one application running, the playback control module 404 plays the audio files corresponding to the applications according to a predetermined rule. In one embodiment, the predetermined rule is defined as the playback control module 404 which plays the audio files according to an order of the running time of the corresponding applications. For example, if the running time of an application is longer than other applications, the playback control module 404 first plays the audio file corresponding to the application. In another embodiment, the predetermined rule defined as the playback control module 404 plays the audio files randomly.

In the present disclosure, if the electronic device 100 is at the standby state and the input unit 20 produces the input signal in response to user operation, such as, the user pressing the power button or touching the touch screen, the user is using the electronic device again. The application determining module 402, the audio file determining module 403, and the playback control module 404 execute their functions as described above, thus producing the audio signals to alert the user as to which applications are running. Therefore, the user can quickly learn which applications are running, and he/she can close unneeded applications, thereby saving power.

If the electronic device 100 is not in the standby state and the input unit 20 produces the input signals in response to user operation, the electronic device 100 is at a normal work state. The application determining module 402, the audio file determining module 403, and the playback control module 404 do not execute their functions and the electronic device 100 does not output the audio signals.

In one embodiment, the processing unit also includes a setting module 405. The setting module 405 is used to set the relationships between the applications and the audio files in response to the user operation and then updates the relationship table.

In one embodiment, the electronic device 100 can be a mobile phone, a tablet computer, a digital photo frame, and the like.

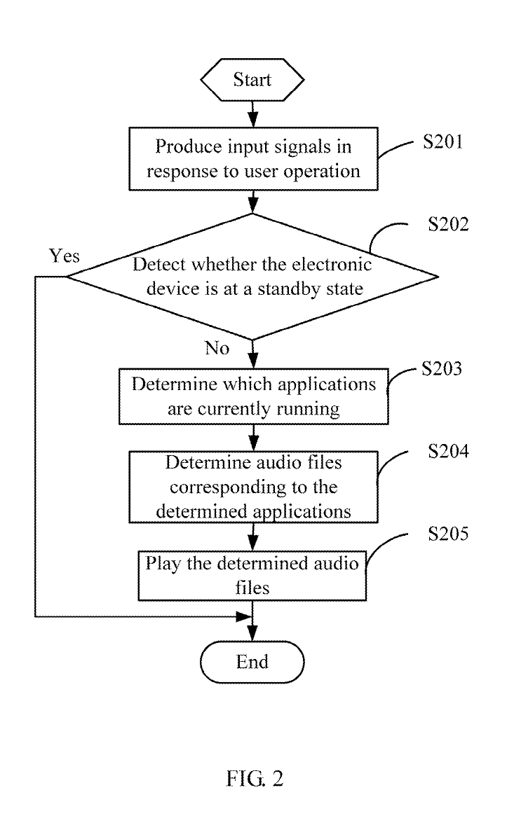

FIG. 2 illustrates one embodiment of a method for alerting running applications. In step S201, the input unit 20 produces input signals in response to user operation.

In step S202, the state detection module 401 detects whether the electronic device 100 is at the standby state when receiving the input signals from the input unit 20.

In step S203, if the state detection module 401 detects the electronic device is not at the standby state, the procedure ends, else, the application determining module 402 determines which applications are currently running.

In step S204, the audio file determining module 403 determines audio files corresponding to the determined applications according to the relationship table.

In step S205, the playback control module 404 plays the determined audio files and controls the audio output unit 40 to output audio signals corresponding to the audio files.

In the embodiment, the method further includes: the setting module 405 sets the relationships between the applications and the audio files in response to user operation.

It is understood that the present embodiments and their advantages will be understood from the foregoing description, and various changes may be made thereto without departing from the spirit and scope of the disclosure or sacrificing all of its material advantages, the examples hereinbefore described merely being exemplary embodiments of the present disclosure.

What is claimed is:

1. An electronic device with a function of alerting running applications, the electronic device comprising:
a storage unit storing a relationship table and a plurality of audio files, wherein the relationship table defines relationships between applications and the audio files;
a input unit configured to produce input signals in response to user operation;
an audio output unit configured to output audio signals; and
a processing unit comprising:
a state detection module configured to detect whether the electronic device is at a standby state when receiving the input signals from the input unit;
an application determining module configured to determine which applications are currently running when the state detection module detects the electronic device is at the standby state;
an audio file determining module configured to determine the audio files corresponding to the running applications according to the relationship table stored in the storage unit; and
a playback control module configured to play the determined audio files and control the audio output unit to output audio signals corresponding to the audio files.

2. The electronic device according to claim 1, wherein the processing unit further comprises a setting module configured to set the relationships between the applications and the audio files in response to the user operation.

3. The electronic device according to claim 1, wherein if the application determining module determines that there is only one running application, the playback control module plays a single audio file corresponding to the application.

4. The electronic device according to claim 1, wherein, if the application determining module determines that there are a plurality of running applications, the playback control module plays the audio files corresponding to the applications according to a predetermined rule.

5. The electronic device according to claim 4, wherein the predetermined rule is defined as the playback control module playing the audio files randomly.

6. The electronic device according to claim 4, wherein the predetermined rule is defined as the playback control module playing the audio files according to an order of the running time of the corresponding applications.

7. The electronic device according to claim 1, wherein the electronic device is a mobile phone, a tablet computer, or a digital photo frame.

8. A method for alerting running applications, applied in an electronic device comprising a storage unit storing a relationship table and a plurality of audio files, the relationship table defining relationships between applications and the audio files, a input unit configured to produce input signals in response to user operation, an audio output unit configured to output audio signals, and a processing unit, the method comprising:
producing the input signals in response to user operation via the input unit;
detecting whether the electronic device is at the standby state via the processing unit;
determining which applications are currently running via the processing unit;
determining audio files corresponding to the determined applications according to the relationship table stored in the storage unit via the processing unit; and
playing the determined audio files and controlling the audio output unit to output audio signals corresponding to the determined audio files via the processing unit.

9. The method according to claim 8, further comprising:
setting the relationships between the applications and the audio files in response to user operation.

10. The method according to claim 8, wherein the step of playing the determined audio files and controlling the audio output unit to output audio signals corresponding to the audio files via the processing unit comprises playing a single audio file corresponding to one application if there is only the one running application.

11. The method according to claim 8, wherein the step of playing the determined audio files and controlling the audio output unit to output audio signals corresponding to the audio files via the processing unit comprises playing the audio files corresponding to the applications according to a predetermined rule if there are a plurality of running applications.

12. The method according to claim 11, wherein the predetermined rule is defined as randomly playing the audio files corresponding to the applications.

13. The method according to claim 11, wherein the predetermined rule is defined as playing the audio files according to an order of the running time of the corresponding applications.
